(19) United States
(12) Patent Application Publication
(10) Pub. No.: US 2015/0211872 A1
(43) Pub. Date: Jul. 30, 2015

(54) NAVIGATION METHOD AND NAVIGATION DEVICE

(71) Applicant: HUAWEI TECHNOLOGIES CO., LTD., Shenzhen (CN)

(72) Inventors: Jianmin WANG, Guangzhou (CN); Fang You, Guangzhou (CN); Chingman Au Yeung, Hong Kong (HK); Xiaojuan Ma, Hong Kong (HK); Xiuqiang He, Shenzhen (CN)

(21) Appl. No.: 14/584,338

(22) Filed: Dec. 29, 2014

(30) Foreign Application Priority Data
Jan. 27, 2014 (CN) 201410041193.5

(51) Int. Cl. G01C 21/34

(52) U.S. Cl. CPC G01C 21/34

(57) ABSTRACT

Embodiments of the present invention disclose a navigation method and a navigation device, which are used to exchange information between different motorists, so that the navigation device can keep abreast of a latest road condition. The method in the embodiments of the present invention includes: acquiring a first destination of a first navigation device; determining a second navigation device, where a distance between a second destination of the second navigation device and the first destination of the first navigation device is less than a first preset distance; and establishing a communication connection between the first navigation device and the second navigation device. In the embodiments of the present invention, different navigation devices can exchange information with each other, so that the navigation devices can keep abreast of the latest road condition.

### CROSS-REFERENCE TO RELATED APPLICATIONS

This application claims priority to Chinese Patent Application No. 201410041193.5, filed on Jan. 27, 2014, which is hereby incorporated by reference in its entirety.

### TECHNICAL FIELD

The present invention relates to the mobile communications field, and in particular, to a navigation method and a navigation device.

### BACKGROUND

As vehicles become popular and cities develop, a vehicle navigation technology is also more widely applied.

An existing vehicle navigation technology is mainly implemented by using a navigation apparatus on a vehicle with a navigation device, where the navigation apparatus mainly calculates an appropriate path based on a start point and an end point that are input on the navigation device, and provides a suggestion of one or more road lines for the navigation device.

However, all existing vehicle navigation technologies are interaction between a navigation device and a navigation apparatus. Although the navigation apparatus may provide some real-time traffic information for the navigation device, the navigation apparatus cannot integrate information of another navigation device that uses a similar navigation apparatus. As a result, transfer of the information is neither timely nor convenient.

### SUMMARY

Embodiments of the present invention provide a navigation method and a navigation device, which are used to exchange information between different motorists, so that the navigation device can keep abreast of a latest road condition.

A first aspect of an embodiment of the present invention provides a navigation method, including:

determining, by a first navigation device, a first destination currently navigated by the first navigation device;

determining, by the first navigation device, a second navigation device, where a distance between a second destination currently navigated by the second navigation device and the first destination is less than a first preset distance; and

establishing, by the first navigation device, a communication connection to the second navigation device.

With reference to the first aspect of the embodiment of the present invention, in a first implementation manner of the first aspect of the embodiment of the present invention, the determining, by the first navigation device, a second navigation device includes:

searching, by the first navigation device, for candidate navigation devices, where a distance between a destination of each candidate navigation device and the first destination is less than the first preset distance, and the number of the candidate navigation devices is greater than 1; and

determining, by the first navigation device, the second navigation device from the candidate navigation devices.

With reference to the first implementation manner of the first aspect of the embodiment of the present invention, in a second implementation manner of the first aspect of the embodiment of the present invention, the method further includes:

acquiring, by the first navigation device, a first departure place of the first navigation device, and acquiring a first navigation path according to the first departure place and the first destination; and

the determining, by the first navigation device, the second navigation device from the candidate navigation devices includes:

determining, by the first navigation device, the second navigation device from the candidate navigation devices, where a navigation path of the second navigation device and the first navigation path meet a preset condition.

With reference to the first implementation manner of the first aspect of the embodiment of the present invention, in a third implementation manner of the first aspect of the embodiment of the present invention, the method further includes: acquiring, by the first navigation device, a first trip purpose of a user who uses the first navigation device; and

the determining, by the first navigation device, the second navigation device from the candidate navigation devices includes:

determining, by the first navigation device, the second navigation device from the candidate navigation devices, where a trip purpose of the second navigation device is the same as the first trip purpose.

With reference to the first implementation manner of the first aspect of the embodiment of the present invention, in a fourth implementation manner of the first aspect of the embodiment of the present invention, each navigation device has one device identifier that is used to uniquely identify the navigation device; and

the method further includes:

acquiring, by the first navigation device, a device identifier input by a user who uses the first navigation device; and

the determining, by the first navigation device, the second navigation device from the candidate navigation devices includes:

determining, by the first navigation device, the second navigation device from the candidate navigation devices, where a device identifier of the second navigation device is the same as the device identifier input by the first user.

A second aspect of an embodiment of the present invention provides a navigation device, including:

a first determining module, configured to determine a first destination currently navigated by a first navigation device;

a second determining module, configured to determine a second navigation device, where a distance between a second destination currently navigated by the second navigation device and the first destination is less than a first preset distance; and

a connecting module, configured to establish a communication connection to the second navigation device.

With reference to the second aspect of the embodiment of the present invention, in a first implementation manner of the second aspect of the embodiment of the present invention, the second determining module includes a searching submodule and a selecting submodule, where:

the searching submodule is configured to search for candidate navigation devices, where a distance between a destination currently navigated by each candidate navigation device and the first destination is less than the first preset distance; and

the selecting submodule is configured to determine the second navigation device from the candidate navigation devices.

With reference to the first implementation manner of the second aspect of the embodiment of the present invention, in a second implementation manner of the second aspect of the embodiment of the present invention, the navigation device further includes:

an acquiring module, configured to acquire a first departure place of the first navigation device, and acquire a first navigation path according to the first departure place and the first destination; and

the selecting submodule is specifically configured to determine the second navigation device from the candidate navigation devices, where a navigation path of the second navigation device and the first navigation path meet a preset condition.

With reference to the first implementation manner of the second aspect of the embodiment of the present invention, in a third implementation manner of the second aspect of the embodiment of the present invention, the acquiring module is further configured to acquire a first trip purpose of a user who uses the first navigation device; and

the selecting submodule is specifically configured to determine the second navigation device from the candidate navigation devices, where a trip purpose of the second navigation device is the same as the first trip purpose.

With reference to the first implementation manner of the second aspect of the embodiment of the present invention, in a fourth implementation manner of the second aspect of the embodiment of the present invention, each navigation device has one device identifier that is used to uniquely identify the navigation device;

the acquiring module is further configured to acquire a device identifier input by the first user who uses the first navigation device; and

the selecting submodule is specifically configured to determine the second navigation device from the candidate navigation devices, where a device identifier of the second navigation device is the same as the device identifier input by the first user.

It can be seen from the foregoing technical solutions that the embodiments of the present invention have the following advantages:

In the embodiments of the present invention, communication with a second navigation device that has a same or near destination is established, so that some information about the destination or another road section can be exchanged with the second navigation device, so that a navigation device can keep abreast of a latest road condition. In this way, information transfer in a navigation process is more timely and convenient.

### BRIEF DESCRIPTION OF DRAWINGS

FIG. 1 is a flowchart of a navigation method according to an embodiment of the present invention;

FIG. 2 is a flowchart of a navigation method according to another embodiment of the present invention;

FIG. 3 is a flowchart of a navigation method according to another embodiment of the present invention;

FIG. 4 is a flowchart of a navigation method according to another embodiment of the present invention;

FIG. 5 is a flowchart of a navigation method according to another embodiment of the present invention;

FIG. 6 is a flowchart of a navigation method according to another embodiment of the present invention;

FIG. 7 is a flowchart of a navigation method according to another embodiment of the present invention;

FIG. 8 is a schematic diagram of a navigation device according to an embodiment of the present invention;

FIG. 9 is a schematic diagram of a navigation device according to another embodiment of the present invention;

FIG. 10 is a schematic diagram of a navigation device according to another embodiment of the present invention;

FIG. 11 is a schematic diagram of a vehicle-mounted GPS device according to an embodiment of the present invention; and

FIG. 12 is a structural diagram of an inner part of a vehicle-mounted GPS device according to an embodiment of the present invention.

### DESCRIPTION OF EMBODIMENTS

Embodiments of the present invention provide a navigation method and a navigation device, which are used to exchange information between different motorists, so that the navigation device can keep abreast of a latest road condition.

To make persons skilled in the art understand the solutions in the present invention better, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

Terms “first”, “second”, “third”, “fourth”, and the like (if they exist) in the specification, the claims, and the accompanying drawings of the present invention are used to distinguish similar objects and are not necessarily used to describe a specific sequence or a precedence order. It should be understood that data used in this way may be interchanged in an appropriate situation, so that the embodiments described herein can be implemented in a sequence except content illustrated or described herein. In addition, terms “include” and “have” and their any other variants are intended to cover non-exclusive containing, for example, a process, a method, a system, a product, or a device that includes a series of steps or units is not necessarily limited to those expressly listed steps or units, but may include another step or unit that is not expressly listed or is inherent to the process, the method, the product, or the device.

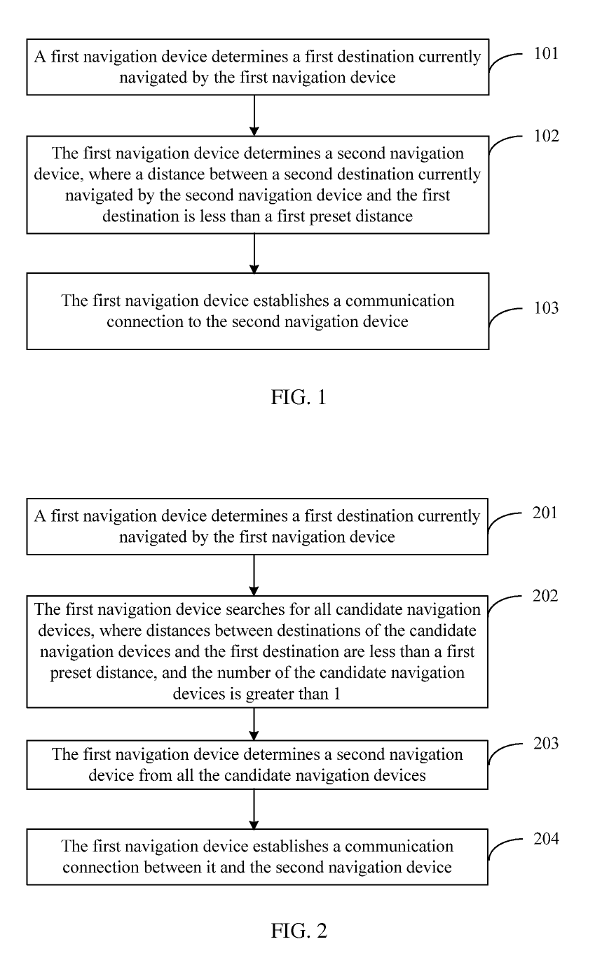

Referring to FIG. 1, a navigation method in an embodiment of the present invention includes:

101. A first navigation device determines a first destination currently navigated by the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the destination of the first navigation device by acquiring input of a user who uses the first navigation device, or the first navigation device may also set the destination by default.

102. The first navigation device determines a second navigation device, where a distance between a second destination currently navigated by the second navigation device and the first destination is less than a first preset distance.

The first navigation device determines the second navigation device according to the destination input by the user who uses the first navigation device, where the distance between a destination of the second navigation device and a destination of the user who uses the first navigation device is less than the first preset distance, and the first preset distance may be acquired by the first navigation device from a manual setting of the user and may also be set by the first navigation device by default. In an actual application, the distance may be a route distance or may be a straight-line distance. Certainly, in an actual application, the distance may also be another distance, which is not limited herein. It should be noted that the second navigation device may include only one navigation device or may include at least two navigation devices, where a distance between a destination of each navigation device in the second navigation device and the destination of the first navigation device is less than the first preset distance. The specific number of navigation devices included in the second navigation device may be acquired by the first navigation device from the manual setting of the user or may be set by the first navigation device by default.

103. The first navigation device establishes a communication connection to the second navigation device.

The communication connection established between the first navigation device and the second navigation device by the first navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to a server through the communication connection, and then the server sends the information to the second navigation device. Certainly, the foregoing description is only exemplary illustration and does not impose a limitation.

In this embodiment of the present invention, by establishing communication with a second navigation device that has a same or near destination, a first navigation device can exchange some information about the destination or another road section with the second navigation device, so that the first navigation device can keep abreast of a latest road condition. In this way, information transfer in a navigation process is more timely and convenient.

In the foregoing embodiment, a navigation device needs to determine a second navigation device before establishing a communication connection between a first navigation device and the second navigation device. In an actual application, the navigation device may confirm the second navigation device in multiple manners. The following describes a navigation method in the embodiment of the present invention. Referring to FIG. 2, a navigation method in another embodiment of the present invention includes:

201. A first navigation device determines a first destination currently navigated by the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The navigation device may acquire, by acquiring input of a user who uses the first navigation device, the first destination currently navigated by the first navigation device, or the first navigation device may also set the first destination by default.

Optionally, the first navigation device may further acquire a first trip purpose of the first user who uses the first navigation device. The first trip purpose refers to an intention of the first user going to the first destination. The first navigation device may acquire the first trip purpose of the first user in multiple manners. The following is a specific example.

A one-to-one correspondence table between different types of destination and different trip purposes is preset in the first navigation device; after acquiring the destination currently navigated by the first navigation device, the first navigation device finds, from the correspondence table, the first trip purpose corresponding to the destination. For example, in the lookup table, a trip purpose corresponding to a destination such as a gymnasium, a badminton hall, and a football field is doing exercise; when the destination currently navigated by the first navigation device is a gymnasium, the first navigation device acquires, from the lookup table, that the first trip purpose of the first user who uses the first navigation device is doing exercise.

Alternatively, after acquiring the first destination currently navigated by the first navigation device, the first navigation device may further display multiple trip purpose options in a display interface of the first navigation device or prompt multiple trip purpose options by means of a voice for the first user who uses the first navigation device to select, and acquire a selection made by the first user as the first trip purpose of the first user. For example, after the first navigation device acquires the first destination currently navigated by the first navigation device, the following trip purpose options appear in the display interface of the first navigation device: doing exercise, shopping, recreation, working, and the like; then a selection made by the first user who uses the first navigation device from the trip purpose options is acquired, and the selection is used as the first trip purpose of the first user. Certainly, in an actual application, each of the trip purpose options may further have multiple sub-options; after the first navigation device acquires one option selected by the first user, at least two sub-options below the option appear in the display interface of the first navigation device for the first user to select again, and the second selection is used as the first trip purpose of the first user.

Certainly, in an actual application, the first navigation device may also not acquire the first trip purpose of the first user who uses the first navigation device.

202. The first navigation device searches for all candidate navigation devices, where a distance between a destination of each candidate navigation device and the first destination is less than a first preset distance, and the number of the candidate navigation devices is greater than 1.

The first navigation device downloads, from a navigation server, destinations currently navigated by other navigation devices, and screens out all the candidate navigation devices according to the first destination currently navigated by the first navigation device, where the number of all the candidate navigation devices is greater than 1. In this embodiment, the distances between the destinations currently navigated by all the candidate navigation devices and the destination currently navigated by the first navigation device are less than the first preset distance. In an actual application, the distances may be route distances or may be straight-line distances. Certainly, in an actual application, the distances may also be other distances, which are not limited herein.

Certainly, it may also be that the first navigation device sends the first destination currently navigated by the first navigation device to the navigation server, and the navigation server screens out all the candidate navigation devices according to the first destination and sends the candidate navigation devices to the first navigation device, where the distance between the destination currently navigated by each candidate navigation device and the first destination is less than the first preset distance.

Preferably, in a case in which the first navigation device acquires the first trip purpose of the first user who uses the first navigation device, it may also be that the distances between the destinations of all the candidate navigation devices and the destination of the first navigation device are less than the first preset distance, and trip purposes of all users who use the candidate navigation devices are also the same as the first trip purpose.

203. The first navigation device determines a second navigation device from all the candidate navigation devices.

In an actual application, the first navigation device may determine the second navigation device in multiple manners. For a specific example, after screening out all the candidate navigation devices meeting a requirement, the first navigation device presents all the candidate navigation devices to the user of the first navigation device by displaying information about all the candidate navigation devices in the display interface of the first navigation device. For example, the first navigation device may display navigation device names of all the candidate navigation devices in the display interface of the first navigation device. Certainly, the foregoing description is only exemplary illustration and does not impose a limitation. The first navigation device presents the information about all the candidate navigation devices to the user who uses the first navigation device, acquires at least one candidate navigation device selected by the user from all the candidate navigation devices, and determines the acquired at least one candidate navigation device as the second navigation device.

Alternatively, after the first navigation device screens out all the candidate navigation devices meeting the requirement, a navigation device ranked first, at least two navigation devices ranked in the front, a navigation device ranked last, or at least two navigation devices ranked last are determined as the second navigation device according to a default setting. Alternatively, after the first navigation device screens out all the candidate navigation devices meeting the requirement, it may also be that one navigation device or at least two navigation devices are randomly chosen from the candidate navigation devices and determined as the second navigation device.

204. The first navigation device establishes a communication connection between the first navigation device and the second navigation device.

The communication connection established by the first navigation device between the first navigation device and the second navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to a server through the communication connection, and then the server sends the information to the second navigation device. Certainly, the foregoing description is only exemplary illustration and does not impose a limitation.

In this embodiment, a first navigation device searches for a second navigation device of which a destination is the same as or near a destination of the first navigation device, and establishes a communication connection to the second navigation device, which can automatically search for another navigation device related to the first navigation device for the first navigation device, helps the first navigation device acquire information related to the first navigation device, and improves user experience of a navigation device.

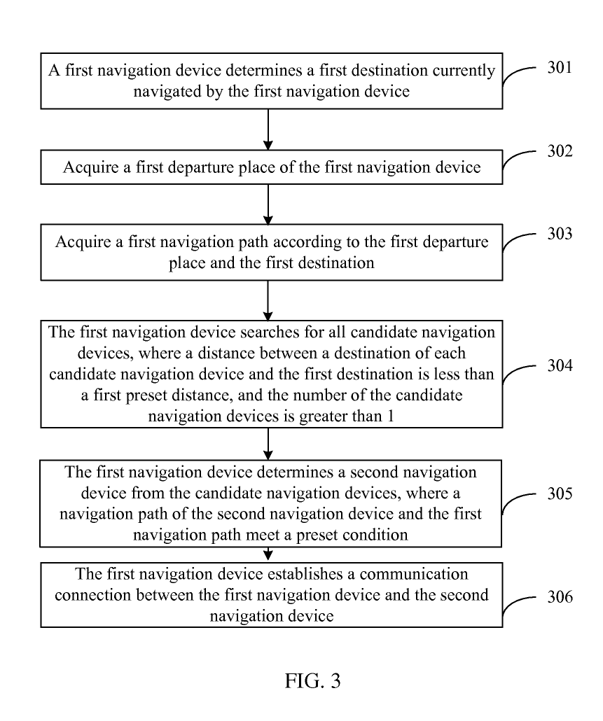

In the foregoing embodiment, a distance between a destination currently navigated by each candidate navigation device that is searched for by a first navigation device and a first destination is less than a first preset distance. In an actual application, it may also be that the distance between the destination currently navigated by each candidate navigation device that is searched for by the first navigation device and the first destination is less than the first preset distance, and a distance between a navigation path of the candidate navigation device and a navigation path of the first navigation device is less than a second preset distance. The following describes a navigation method in the embodiments of the present invention. Referring to FIG. 3, a navigation method in another embodiment of the present invention includes:

301. A first navigation device determines a first destination currently navigated by the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the destination of the first navigation device by acquiring input of a user who uses the first navigation device, or the first navigation device may also set the destination by default.

302. Acquire a first departure place of the first navigation device.

The first navigation device may acquire the first departure place of the first navigation device by acquiring the input of the user who uses the first navigation device, or the first navigation device may also acquire the first departure place of the first navigation device by detecting, by using the GPS or a wireless network, a current position of the first navigation device.

303. Acquire a first navigation path according to the first departure place and the first destination.

The first navigation device has an embedded map and acquires the first navigation path according to the acquired first departure place and first destination that are currently navigated by the first navigation device. There are generally multiple paths between the first departure place and the first destination of the first navigation device, and the first navigation device may use a path with a shortest length as the first navigation path. Certainly, in an actual application, the first navigation device may also separately calculate candidate paths such as the path with the shortest length and a path with minimum traffic lights, present the candidate paths to the first user who uses the first navigation device, and acquire, as the first navigation path, a candidate path selected by the first user.

Alternatively, it may also be that the first navigation device sends the first departure place and the first destination that are currently navigated by the first navigation device to a navigation server, the navigation server calculates a first navigation path, and then the first navigation device downloads the first navigation path from the navigation server; alternatively, the navigation server calculates different candidate paths, and then the first navigation device downloads the candidate paths from the navigation server, presents the candidate paths to the first user who uses the first navigation device, and acquires, as the first navigation path, a candidate path selected by the first user. Certainly, the foregoing description is only exemplary illustration and does not impose a limitation.

304. The first navigation device searches for all candidate navigation devices, where a distance between a destination of each candidate navigation device and the first destination is less than a first preset distance, and the number of the candidate navigation devices is greater than 1.

The first navigation device downloads destinations currently navigated by other navigation devices from the navigation server, and screens out all the candidate navigation devices according to the first destination currently navigated by the first navigation device, where the number of all the candidate navigation devices is greater than 1. In this embodiment, the distances between the destinations currently navigated by all the candidate navigation devices and the destination currently navigated by the first navigation device are less than the first preset distance. In an actual application, the distances may be route distances or may be straight-line distances. Certainly, in an actual application, the distances may also be other distances, which are not limited herein.

Certainly, it may also be that the first navigation device sends the first destination currently navigated by the first navigation device to the navigation server, and the navigation server screens out all the candidate navigation devices according to the first destination and sends them to the first navigation device, where the distance between the destination currently navigated by the candidate navigation device and the first destination is less than the first preset distance.

305. The first navigation device determines a second navigation device from the candidate navigation devices, where a navigation path of the second navigation device and the first navigation path meet a preset condition.

For a specific example, the preset condition may be that a distance between a destination currently navigated by the second navigation device and the first destination is less than the first preset distance, and a degree of coincidence between a navigation path of the second navigation device and the first navigation path is greater than a preset value. The degree of coincidence between the navigation path of the second navigation device and the first navigation path of the first navigation device refers to a ratio of a length of a coinciding path in the first navigation path and the navigation path of the second navigation device to a total length of the first navigation path. A specific value of the preset value may be set by the first navigation device by default, and may also be set by the first navigation device by acquiring the input of the first user who uses the first navigation device.

In an actual application, it may not be that the degree of coincidence between the navigation path of the second navigation device and the first navigation path is greater than the preset value. Instead, another condition is met. For example, a distance between a middle point of the navigation path of the second navigation device and a middle point of the first navigation path is less than a preset value, or a distance between a start point of the navigation path of the second navigation device and the first departure place is less than a preset value.

306. The first navigation device establishes a communication connection between the first navigation device and the second navigation device.

The communication connection established by the first navigation device between the first navigation device and the second navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to a server through the communication connection, and then the server sends the information to the second navigation device. Certainly, the foregoing description is only exemplary illustration and does not impose a limitation.

In this embodiment, a first navigation device searches for a second navigation device with a destination the same as or near a destination of the first navigation device and whose navigation path and a navigation path of a first navigation path meet a preset condition, and establishes a communication connection to the first navigation device, which can automatically search for another navigation device more related to the first navigation device for the first navigation device, helps the first navigation device acquire information related to the first navigation device, and improves user experience of a navigation device.

In an actual application, the second navigation device found by the first navigation device may also meet the following three conditions at the same time: a distance between the destination of the second navigation device and the destination currently navigated by the first navigation device is less than a first preset distance, the navigation path of the second navigation device and the first navigation path meet the preset condition, and a trip purpose of a user who uses the second navigation device is the same as a first trip purpose. The first navigation device may even further set another screening condition, so that the determined second navigation device better meets a requirement of a first user who uses the first navigation device.

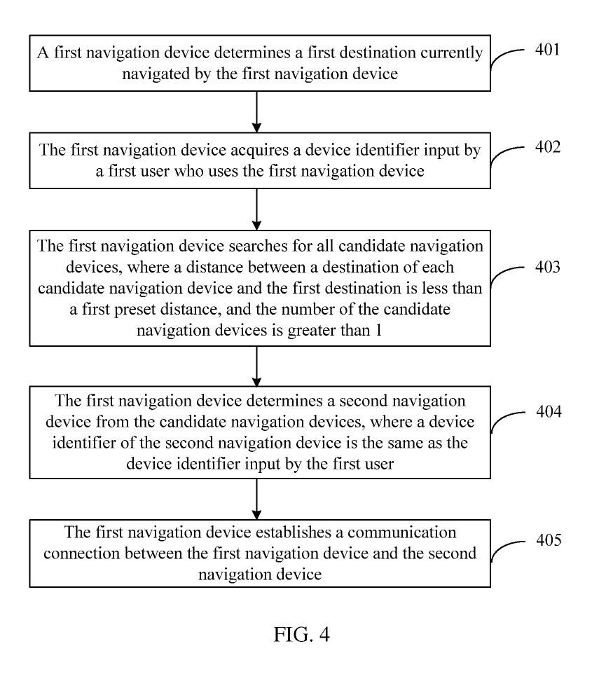

In the foregoing embodiment, a first navigation device determines a second navigation device by means of automatic searching. In an actual application, the first navigation device may also determine the second navigation device by acquiring a device identifier input by a first user who uses the first navigation device. Referring to FIG. 4, a navigation method in another embodiment of the present invention includes:

401. A first navigation device determines a first destination currently navigated by the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the destination of the first navigation device by acquiring input of a user who uses the first navigation device, or the first navigation device may also set the destination by default.

402. The first navigation device acquires a device identifier input by a first user who uses the first navigation device.

Each navigation device has its own device identifier, which is used to uniquely identify the navigation device. If the first navigation device needs to connect to a specific second navigation device, the first navigation device may directly acquire the device identifier of the second navigation device, where the device identifier is input by the first user who uses the first navigation device. Certainly, the number of the second navigation devices is not limited to one. If the first navigation device needs to connect to at least two second navigation devices, the first navigation device may separately acquire a device identifier of each navigation device among the second navigation devices and perform searching, where the device identifier is input by the first user.

403. The first navigation device searches for all candidate navigation devices, where a distance between a destination of each candidate navigation device and the first destination is less than a first preset distance, and the number of the candidate navigation devices is greater than 1.

The first navigation device downloads, from a navigation server, destinations currently navigated by other navigation devices, and screens out all the candidate navigation devices according to the first destination currently navigated by the first navigation device, where the number of all the candidate navigation devices is greater than 1. In this embodiment, the distances between the destinations currently navigated by all the candidate navigation devices and the destination currently navigated by the first navigation device are less than the first preset distance. In an actual application, the distances may be route distances or may be straight-line distances. Certainly, in an actual application, the distances may also be other distances, which are not limited herein.

Certainly, it may also be that the first navigation device sends the first destination currently navigated by the first navigation device to the navigation server, and the navigation server screens out all the candidate navigation devices according to the first destination and sends them to the first navigation device, where the distance between the destination currently navigated by the candidate navigation device and the first destination is less than the first preset distance.

404. The first navigation device determines a second navigation device from the candidate navigation devices, where a device identifier of the second navigation device is the same as the device identifier input by the first user.

After determining all the candidate navigation devices, the first navigation device finds all target candidate navigation devices meeting the following condition from the candidate navigation devices: a device identifier of a target candidate navigation device is the same as the device identifier input by the first user, and the target candidate navigation device is determined as the second navigation device.

Certainly, in an actual application, the device identifier of the second navigation device may also be not exactly the same as the device identifier input by the first user, and may also be at least partially the same as the device identifier input by the first user. That is, the second navigation device is determined by using a fuzzy matching principle. In this way, it may be avoided that the first user cannot find a required navigation device because some characters remembered by the first user are incorrect.

405. The first navigation device establishes a communication connection between the first navigation device and the second navigation device.

The communication connection established between the first navigation device and the second navigation device by the first navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to a server through the communication connection, and then the server sends the information to the second navigation device. Certainly, the foregoing description is only exemplary illustration and does not impose a limitation.

After the first navigation device determines the second navigation device, the first navigation device may directly establish the communication connection between the first navigation device and the second navigation device, or may also present the second navigation device to the first user who uses the first navigation device and send an inquiry request, where the inquiry request is used to confirm whether the first user wants to establish the communication connection to the second navigation device.

In this embodiment, a first navigation device is input with a navigation device name of a second navigation device that needs to be connected, so as to search for the second navigation device. In this way, the second navigation device connected to the navigation device better meets a requirement of the first navigation device, which improves use experience of the navigation device.

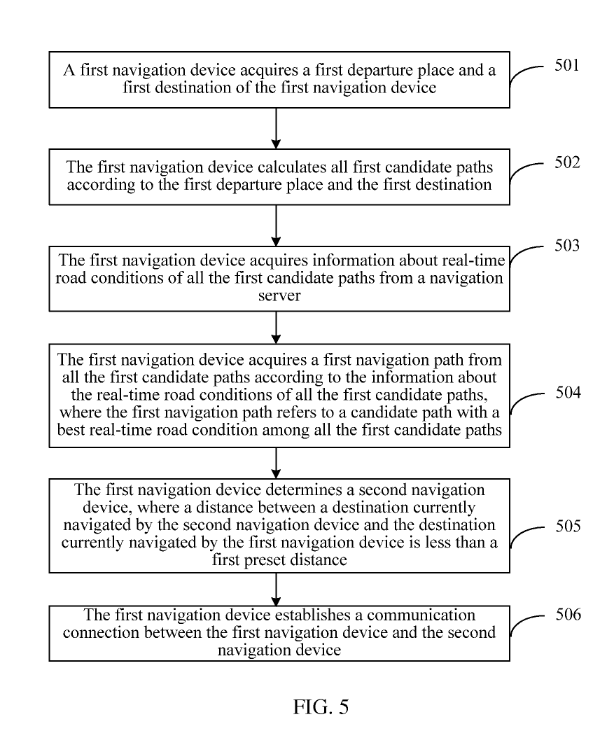

In the foregoing embodiment, a navigation device acquires a first navigation path according to a first departure place and a first destination of a first navigation device. In an actual application, the navigation device may perform the acquiring in multiple manners. The following describes a navigation method in an embodiment of the present invention. Referring to FIG. 5, a navigation method in another embodiment of the present invention includes:

501. A first navigation device acquires a first departure place and a first destination of the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the departure place and the destination of the first navigation device by acquiring input of a user who uses the first navigation device, or the navigation device may also acquire the departure place of the first navigation device by detecting, by using the GPS or a wireless network, a current position of the first navigation device.

502. The first navigation device calculates all first candidate paths according to the first departure place and the first destination.

The first navigation device is embedded with a map and acquires a path according to the acquired first departure place and first destination. There are generally multiple paths between the first departure place and the first destination, and the first navigation device calculates each of the paths as candidate paths. Certainly, in an actual application, it may also be that the first navigation device sends the acquired first departure place and first destination to a navigation server, the navigation server calculates each of the paths, and then the first navigation device downloads each of the paths from the navigation server as the first candidate paths.

503. The first navigation device acquires information about real-time road conditions of all the first candidate paths from a navigation server.

The navigation server may acquire information about a real-time road condition of each of the paths in multiple manners. For a specific example, by disposing a camera or a sensor, such as an induction coil that is used to sense a vehicle, at a specified position within a specific area range, where the specified position may be a main road, an intersection, or the like in a city, the navigation server learns information about various real-time road conditions in a photo taking or an induction manner, for example, where is congested and where is unobstructed within the area range. Alternatively, the navigation server acquires the information about the real-time road conditions from a partner server, for example, a transportation department of a government may obtain information about real-time road conditions of an entire city by using a huge monitoring network, and in this case, the navigation server may share, in real time by connecting to a server of the transportation department through a network, the information about the real-time road conditions that is obtained by the transportation department. The first navigation device only needs to download the information about the real-time road conditions of all the first candidate paths from the navigation server.

504. The first navigation device acquires a first navigation path from all the first candidate paths according to the information about the real-time road conditions of all the first candidate paths, where the first navigation path refers to a candidate path with a best real-time road condition among all the first candidate paths.

After downloading the information about the real-time road conditions of all the first candidate paths from the navigation server, the first navigation device chooses the candidate path with the best real-time road condition as the first navigation path according to the information about the real-time road condition of each of the first candidate paths. The first candidate path with the best real-time road condition may refer to a path with a shortest length determined by calculating, may also refer to a path with minimum traffic flow, may also be a better path determined after a length is balanced against traffic, or the like. The foregoing description is only exemplary illustration and does not impose a limitation. The first navigation device may use one of the foregoing paths as the path with the best real-time road condition by default, or may also calculate all the paths and present the paths to the user who uses the first navigation device, the user decides which is the path with the best real-time road condition, and then the first navigation device acquires, as the first navigation path, the path with the best real-time road condition selected by the user. Certainly, the foregoing description is only exemplary illustration and does not impose a limitation.

505. The first navigation device determines a second navigation device, where a distance between a destination currently navigated by the second navigation device and the destination currently navigated by the first navigation device is less than a first preset distance.

It should be noted that the first navigation device determines the second navigation device, where the distance between the destination currently navigated by the second navigation device and the destination currently navigated by the first navigation device is less than the first preset distance. Specifically, the first navigation device acquires identifier information of the second navigation device from a server side, that is, the server determines the second navigation device, where the distance between the destination of the second navigation device and the destination of the first navigation device is less than the first preset distance, and then sends the identifier information of the second navigation device to the first navigation device, so that the first navigation device determines the second navigation device. The server may be a server of any network type (such as a GSM network or an LTE network).

The first navigation device determines the second navigation device according to the destination input by the user who uses the first navigation device, where the distance between a destination of the second navigation device and a destination of the user who uses the first navigation device is less than the first preset distance, and the first preset distance may be acquired by the first navigation device from a manual setting of the user and may also be set by the first navigation device by default. In an actual application, the distance may be a route distance or may be a straight-line distance. Certainly, in an actual application, the distance may also be another distance, which is not limited herein. It should be noted that the second navigation device may include only one navigation device or may include at least two navigation devices, where a distance between a destination of each navigation device in the second navigation device and the destination of the first navigation device is less than the first preset distance. The specific number of navigation devices included in the second navigation device may be acquired by the first navigation device from the manual setting of the user or may be set by the first navigation device by default.

506. The first navigation device establishes a communication connection between the first navigation device and the second navigation device.

The communication connection established between the first navigation device and the second navigation device by the first navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to the server through the communication connection, and then the server sends the information to the second navigation device. Certainly, the foregoing description is only exemplary illustration and does not impose a limitation.

In this embodiment, a navigation device acquires information about a real-time road condition of each path from a navigation server to choose a path with a best real-time road condition as a first navigation path, and presents the path to a user of the first navigation device, which improves driving experience of the navigation device.

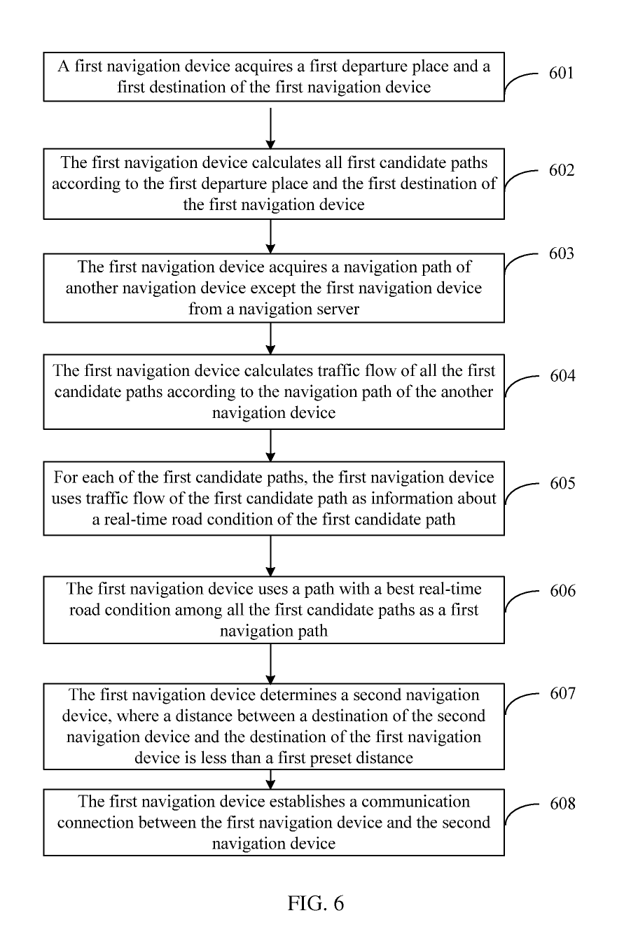

In the foregoing embodiment, a first navigation device acquires information about real-time road conditions of all first candidate paths from a navigation server. In an actual application, the first navigation device may acquire the information about the real-time road conditions of all the candidate paths by acquiring a navigation path of another navigation device. The following describes a navigation method in an embodiment of the present invention. Referring to FIG. 6, a navigation method in another embodiment of the present invention includes:

601. A first navigation device acquires a first departure place and a first destination of the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the departure place and the destination of the first navigation device by acquiring input of a user who uses the first navigation device, or the navigation device may also acquire the departure place of the first navigation device by detecting, by using the GPS or a wireless network, a current position of the first navigation device.

602. The first navigation device calculates all first candidate paths according to the first departure place and the first destination of the first navigation device.

The first navigation device is embedded with a map and acquires a path according to the acquired first departure place and first destination. There are generally multiple paths between the first departure place and the first destination, and the first navigation device calculates each of the paths as candidate paths. Certainly, in an actual application, it may also be that the first navigation device sends the acquired first departure place and first destination to a navigation server, the navigation server calculates each of the paths, and then the first navigation device downloads each of the paths from the navigation server as the first candidate paths.

603. The first navigation device acquires a navigation path of another navigation device except the first navigation device from a navigation server.

All navigation devices determine and report respective navigation paths to the navigation server, or the navigation server determines navigation paths for all navigation devices and then stores the navigation paths. Then, the first navigation device acquires the navigation path of the another navigation device except the first navigation device from the server, where the navigation path is stored on the server.

604. The first navigation device calculates traffic flow of all the first candidate paths according to the navigation path of the another navigation device.

After acquiring the navigation path of the another navigation device except the first navigation device from the navigation server, the first navigation device analyzes information about these navigation paths, for example, monitoring data such as position information, a driving direction, and a driving speed of a vehicle on which each navigation device is located, and analyzing, by collecting the data, which vehicles need to arrive at which road sections at which moments, where is congested, or where is unobstructed, and further calculates the traffic of all the candidate paths.

605. For each of the first candidate paths, the first navigation device uses traffic flow of the first candidate path as information about a real-time road condition of the first candidate path.

After calculating the traffic of each of the first candidate paths, the first navigation device uses the traffic of each of the first candidate paths as the information about the real-time road condition of the first candidate path. Certainly, in an actual application, the information about the real-time road condition of each of the first candidate paths may also not only include the traffic of the candidate path, an analysis and integration may further be performed by combining the information about the real-time road conditions obtained in various manners in step 503, and more accurate information about the real-time road conditions is finally obtained.

606. The first navigation device uses a path with a best real-time road condition among all the first candidate paths as a first navigation path.

After downloading the information about the real-time road conditions of all the first candidate paths from the navigation server and performing the analysis and integration, the first navigation device chooses the first candidate path with the best real-time road condition as the first navigation path according to the information about the real-time road condition of each of the first candidate paths. The first candidate path with the best real-time road condition may refer to a path with a shortest length determined by calculating, may also refer to a path with minimum traffic flow, may also be a better path determined after a length is balanced against traffic, or the like. The foregoing description is only exemplary illustration and does not impose a limitation. The first navigation device may use one of the foregoing paths as the path with the best real-time road condition by default, or may also calculate all the paths and present the paths to the user who uses the first navigation device, the user decides which is the path with the best real-time road condition, and then the first navigation device uses, as the first navigation path, the acquired path with the best real-time road condition selected by the user who uses the first navigation device. Certainly, the foregoing description is only exemplary illustration and does not impose a limitation.

607. The first navigation device determines a second navigation device, where a distance between a destination of the second navigation device and the destination of the first navigation device is less than a first preset distance.

The first navigation device determines the second navigation device according to the destination input by the user who uses the first navigation device, where the distance between a destination of the second navigation device and a destination of the user who uses the first navigation device is less than the first preset distance, and the first preset distance may be acquired by the first navigation device from a manual setting of the user and may also be set by the first navigation device by default. In an actual application, the distance may be a route distance or may be a straight-line distance. Certainly, in an actual application, the distance may also be another distance, which is not limited herein. It should be noted that the second navigation device may include only one navigation device or may include at least two navigation devices, where a distance between a destination of each navigation device in the second navigation device and the destination of the first navigation device is less than the first preset distance. The specific number of navigation devices included in the second navigation device may be acquired by the first navigation device from the manual setting of the user or may be set by the first navigation device by default.

608. The first navigation device establishes a communication connection between the first navigation device and the second navigation device.

The communication connection established between the first navigation device and the second navigation device by the first navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to a server through the communication connection, and then the server sends the information to the second navigation device. Certainly, the foregoing description is only exemplary illustration and does not impose a limitation.

In this embodiment, a first navigation device acquires a navigation path of another navigation device from a navigation server as information about a real-time road condition, so that information about a real-time road condition of each path is more accurate. This can improve driving experience of a navigation device.

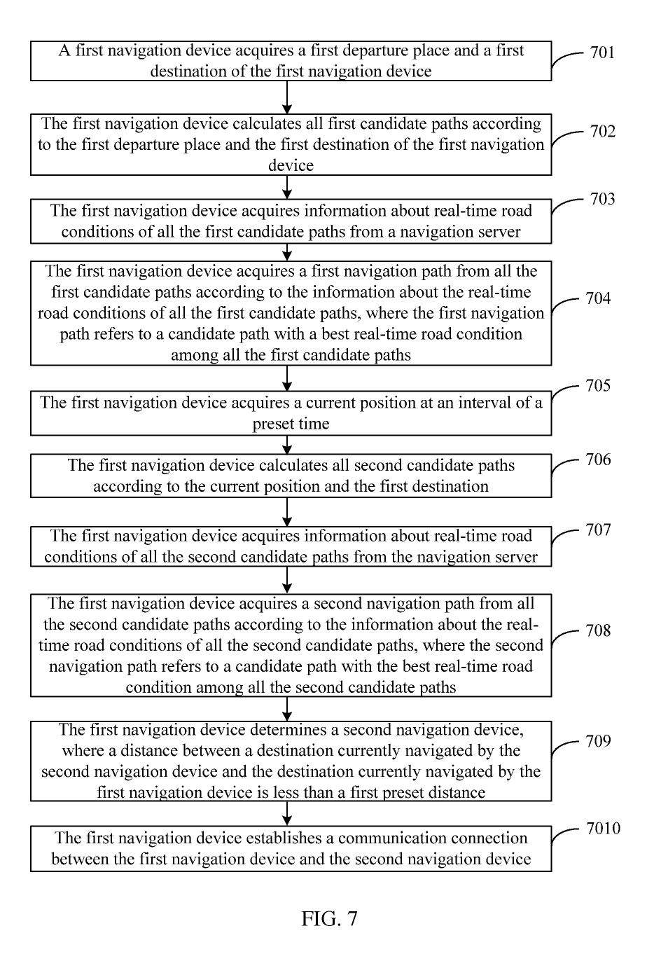

In the foregoing embodiment, a first navigation device acquires information about real-time road conditions of all candidate paths from a navigation server. In an actual application, a real-time road condition of each path may change at different moments, and after acquiring a planned road line, the first navigation device may update the real-time road condition and amend the planned road line. The following describes a navigation method in an embodiment of the present invention. Referring to FIG. 7, a navigation method in another embodiment of the present invention includes:

701. A first navigation device acquires a first departure place and a first destination of the first navigation device.

In this embodiment, the first navigation device is specifically a vehicle-mounted GPS device. Certainly, in an actual application, the first navigation device may also be a mobile phone, a GPS navigator, or another navigation apparatus at a user end, which is not limited herein. The first navigation device may acquire the departure place and the destination of the first navigation device by acquiring input of a user who uses the first navigation device, or the navigation device may also acquire the departure place of the first navigation device by detecting, by using the GPS or a wireless network, a current position of the first navigation device.

702. The first navigation device calculates all first candidate paths according to the first departure place and the first destination of the first navigation device.

The first navigation device is embedded with a map and acquires a path according to the acquired first departure place and first destination. There are generally multiple paths between the first departure place and the first destination, and the first navigation device calculates each of the paths as the first candidate paths. Certainly, in an actual application, it may also be that the first navigation device sends the acquired first departure place and first destination to a navigation server, the navigation server calculates each of the paths, and then the first navigation device downloads each of the paths from the navigation server as the first candidate paths.

703. The first navigation device acquires information about real-time road conditions of all the first candidate paths from a navigation server.

The navigation server may acquire information about a real-time road condition of each of the paths in multiple manners. For a specific example, by disposing a camera or a sensor, such as an induction coil that is used to sense a vehicle, at a specified position within a specific area range, where the specified position may be a main road, an intersection, or the like in a city, the navigation server learns information about various real-time road conditions in a photo taking or an induction manner, for example, where is congested and where is unobstructed within the area range. Alternatively, the navigation server acquires the information about the real-time road conditions from a partner server, for example, a transportation department of a government may obtain information about real-time road conditions of an entire city by using a huge monitoring network, and in this case, the navigation server may share, in real time by connecting to a server of the transportation department through a network, the information about the real-time road conditions that is obtained by the transportation department. The first navigation device only needs to download the information about the real-time road conditions of all the first candidate paths from the navigation server.

704. The first navigation device acquires a first navigation path from all the first candidate paths according to the information about the real-time road conditions of all the first candidate paths, where the first navigation path refers to a candidate path with a best real-time road condition among all the first candidate paths.

After downloading the information about the real-time road conditions of all the first candidate paths from the navigation server, the first navigation device chooses the candidate path with the best real-time road condition as the first navigation path according to the information about the real-time road condition of each of the first candidate paths. The first candidate path with the best real-time road condition may refer to a path with a shortest length determined by calculating, may also refer to a path with minimum traffic flow, may also be a better path determined after a length is balanced against traffic, or the like. The foregoing description is only exemplary illustration and does not impose a limitation. The first navigation device may use one of the foregoing paths as the path with the best real-time road condition by default, or may also calculate all the paths and present the paths to the user who uses the first navigation device, the user decides which is the path with the best real-time road condition, and then the first navigation device acquires, as the first navigation path, the path with the best real-time road condition selected by the user. Certainly, the foregoing description is only exemplary illustration and does not impose a limitation.

705. The first navigation device acquires a current position at an interval of a preset time.

After acquiring the first navigation path, the first navigation device detects the current position of the first navigation device at the interval of the preset time by using the GPS or the wireless network, where the preset time is set by the first navigation device by default.

706. The first navigation device calculates all second candidate paths according to the current position and the first destination.

The first navigation device is embedded with a map and reacquires a path according to the acquired current position and first destination. There are generally multiple paths between the current position and the first destination, and the first navigation device calculates each of the paths as the second candidate paths. Certainly, in an actual application, it may also be that the first navigation device sends the acquired current position and first destination to the navigation server, the navigation server calculates each of the paths, and then the first navigation device downloads each of the paths from the navigation server as the second candidate paths.

707. The first navigation device acquires information about real-time road conditions of all the second candidate paths from the navigation server.

In an actual application, the information about the real-time road condition of each of the paths always changes. To ensure that the navigation path of the first navigation device is the path with the best real-time road condition, the first navigation device re-acquires the second candidate paths at the interval of the preset time. In this case, the information about the real-time road conditions of the second candidate paths is generally different from the information about the real-time road condition of each of the paths when the first navigation device acquires the first candidate paths.

Preferably, the information about the real-time road condition may include an emergency, for example, a traffic accident, a temporary road closure or another significant case occurring on a path, and in this case, the first navigation device acquires the information from the navigation server to redetermine a navigation path.

708. The first navigation device acquires a second navigation path from all the second candidate paths according to the information about the real-time road conditions of all the second candidate paths, where the second navigation path refers to a candidate path with the best real-time road condition among all the second candidate paths.

After the first navigation device acquires information about a real-time road condition of the second navigation path, the previously determined first navigation path may be no longer the path with the best real-time road condition. Therefore, the first navigation device may recalculate the path with the best real-time road condition from the current position to the first destination according to information about a latest real-time road condition, and amend the original first navigation path into the currently calculated second navigation path with the best real-time road condition.

Specifically, after downloading the information about the real-time road conditions of all the second candidate paths from the navigation server and performing an analysis and integration, the first navigation device chooses the second candidate path with the best real-time road condition as the second navigation path according to information about a real-time road condition of each of the second candidate paths. The second candidate path with the best real-time road condition may refer to a path with a shortest length determined by calculating, may also refer to a path with minimum traffic flow, may also be a better path determined after a length is balanced against traffic, or the like. The foregoing description is only exemplary illustration and does not impose a limitation. The first navigation device may use one of the foregoing paths as the path with the best real-time road condition by default, or may also calculate all the paths and present the paths to the user who uses the first navigation device, the user decides which is the path with the best real-time road condition, and then the first navigation device uses, as the second navigation path, the acquired second candidate path with the best real-time road condition selected by the user who uses the first navigation device. Certainly, the foregoing description is only exemplary illustration and does not impose a limitation.

709. The first navigation device determines a second navigation device, where a distance between a destination currently navigated by the second navigation device and the destination currently navigated by the first navigation device is less than a first preset distance.

It should be noted that the first navigation device determines the second navigation device, where the distance between the destination currently navigated by the second navigation device and the destination currently navigated by the first navigation device is less than the first preset distance. Specifically, the first navigation device acquires identifier information of the second navigation device from a server side, that is, the server determines the second navigation device, where the distance between the destination of the second navigation device and the destination of the first navigation device is less than the first preset distance, and then sends the identifier information of the second navigation device to the first navigation device, so that the first navigation device determines the second navigation device. The server may be a server of any network type (such as a GSM network or an LTE network).

The first navigation device determines the second navigation device according to the destination input by the user who uses the first navigation device, where the distance between a destination of the second navigation device and a destination of the user who uses the first navigation device is less than the first preset distance, and the first preset distance may be acquired by the first navigation device from a manual setting of the user and may also be set by the first navigation device by default. In an actual application, the distance may be a route distance or may be a straight-line distance. Certainly, in an actual application, the distance may also be another distance, which is not limited herein. It should be noted that the second navigation device may include only one navigation device or may include at least two navigation devices, where a distance between a destination of each navigation device in the second navigation device and the destination of the first navigation device is less than the first preset distance. The specific number of navigation devices included in the second navigation device may be acquired by the first navigation device from the manual setting of the user or may be set by the first navigation device by default.

7010. The first navigation device establishes a communication connection between the first navigation device and the second navigation device.

The communication connection established between the first navigation device and the second navigation device by the first navigation device may be in a point-to-point manner, that is, information sent by the first navigation device to the second navigation device through the communication connection may be directly transferred to the second navigation device; alternatively, the communication connection may also be in a forwarding manner, that is, the first navigation device first sends information to the server through the communication connection, and then the server sends the information to the second navigation device. Certainly, the foregoing description is only exemplary illustration and does not impose a limitation.

In this embodiment, a first navigation device may amend a navigation path according to information about a latest real-time road condition, so as to avoid encountering a condition, such as road closure, road repair, or congestion, thereby improving the travel efficiency of a user who uses the first navigation device.

In the foregoing embodiment, after a first navigation device establishes a communication connection between it and a second navigation device, the first navigation device may acquire communication information input by a user who uses the first navigation device, and send the communication information to the second navigation device through the communication connection; and/or the first navigation device receives, through the communication connection, communication information sent by the second navigation device, and presents the communication information to the first user who uses the first navigation device.

The communication information may be voice data, text data, image data, video data, or at least any two thereof. Certainly, the foregoing description is only exemplary illustration and does not impose a limitation on the communication information. The communication information is transferred between the first navigation device and the second navigation device through the communication connection. For a specific example, after the first navigation device establishes the communication connection to the second navigation device, the first user speaks a segment of speech asking the other party for a road condition, and the first navigation device acquires the voice data, or the first user inputs a text or a picture and the first navigation device acquires the text data or the image data, and sends the text data or the image data to the second navigation device through the communication connection. The first navigation device receives, through the communication connection, the communication information sent by the second navigation device, and displays the text data or the image data by using a display interface, so as to present the text data or the image data to the first user who uses the first navigation device, or plays the speech to present to the first user. Alternatively, the communication information sent by the first navigation device to the second navigation device may also be a request for acquiring a navigation path of the other party, and after the second navigation device agrees, the first navigation device receives a navigation path sent by the second navigation device, and presents the navigation path in the display interface of the first navigation device to the user who uses the first navigation device.

In this embodiment, a navigation device may establish a communication connection between a first navigation device and another navigation device to help the first navigation device and the another navigation device exchange information required by each other, thereby improving user experience of the navigation device.

For ease of understanding, the following describes the navigation method in this embodiment by using an actual application scenario.

A first user needs to drive from place A to place B. After the first user starts a vehicle-mounted GPS device, the vehicle-mounted GPS device detects its current position by using the GPS, and the first user manually inputs a specific position of place B. After acquiring a first departure place and a first destination of the first user, the vehicle-mounted GPS device calculates multiple paths between the first departure place and the first destination according to an embedded map, and uses each of the paths as first candidate paths.

Then, the vehicle-mounted GPS device acquires information about real-time road conditions of all the first candidate paths from a navigation server, calculates a predicted real-time road condition of each of the first candidate paths in a current period of time, and then chooses a path with a best real-time road condition as a first navigation path and presents the path to the first user, where the information about the real-time road conditions includes navigation paths of all other navigation devices except the vehicle-mounted GPS device, a current real-time road condition of each of the first candidate paths, an emergency occurring on each of the first candidate paths, and the like.

Afterwards, the navigation device acquires a current position every ten minutes, calculates all second candidate paths according to the current position and the first destination, acquires information about latest real-time road conditions of all the second candidate paths from the navigation server, and selects a path with the best real-time road condition from all the second candidate paths as a second navigation path according to the information about the latest real-time road conditions, so as to amend the first navigation path.

The first navigation device searches for all candidate navigation devices according to the first destination and presents information about all the candidate navigation devices to the first user by using a display interface of the first navigation device, where the first navigation device selects navigation devices with a distance between a destination and the first destination less than one hundred meters as the candidate navigation devices by default.

The first navigation device selects three candidate navigation devices among all the candidate navigation devices. The navigation device uses the three candidate navigation devices as second navigation devices and establishes communication connections between the first navigation device and the second navigation devices. The first user inputs text data into the first navigation device, and the first navigation device acquires the text data and sends it to each navigation device among the second navigation devices.

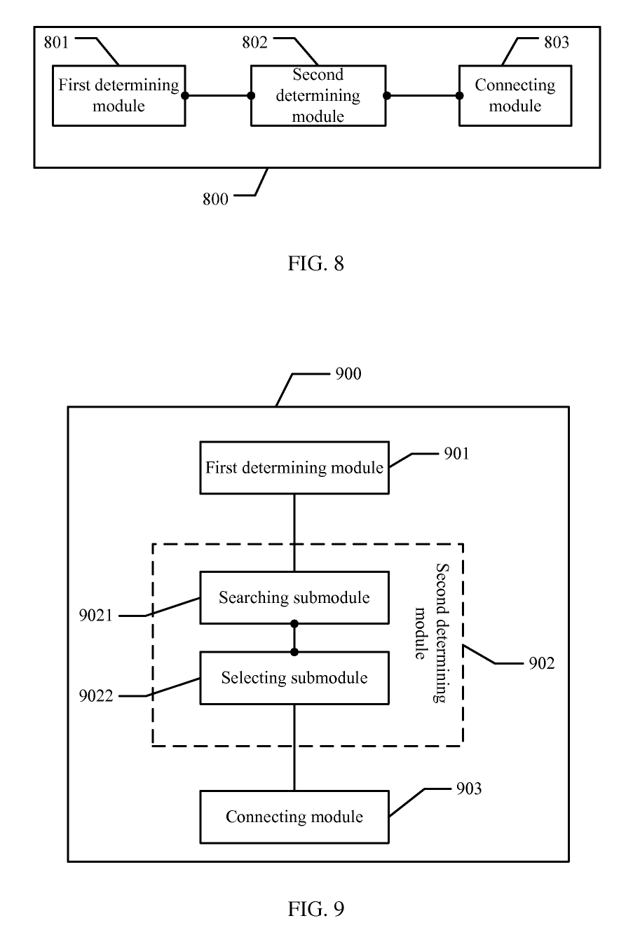

The foregoing describes the navigation methods in the embodiments of the present invention. The following describes a navigation device in an embodiment of the present invention. Referring to FIG. 8, a navigation device 800 in an embodiment of the present invention includes: a first determining module 801, configured to determine a first destination currently navigated by a first navigation device;

a second determining module 802, configured to determine a second navigation device, where a distance between a second destination currently navigated by the second navigation device and the first destination is less than a first preset distance; and a connecting module 803, configured to establish a communication connection between the first navigation device and the second navigation device.

In this embodiment of the present invention, a first navigation device establishes communication with a second navigation device that has a same or near destination, so that the first navigation device can exchange some information about the destination or another road section with the second navigation device, and the first navigation device can keep abreast of a latest road condition. In this way, information transfer in a navigation process is more timely and convenient.

In the foregoing embodiment, a first navigation device needs to determine a second navigation device before establishing a communication connection between the first navigation device and the second navigation device. In an actual application, the first navigation device may confirm the second navigation device in multiple manners. The following describes a navigation device in an embodiment of the present invention. Referring to FIG. 9, a navigation device 900 in another embodiment of the present invention includes:

a first determining module 901, configured to determine a first destination currently navigated by a first navigation device;

a second determining module 902, configured to determine a second navigation device, where a distance between a second destination currently navigated by the second navigation device and the first destination is less than a first preset distance; and

a connecting module 903, configured to establish a communication connection between the first navigation device and the second navigation device.

In this embodiment of the present invention, the second determining module 902 specifically includes:

a searching submodule 9021, configured to search for candidate navigation devices, where a distance between a destination currently navigated by each candidate navigation device and the first destination is less than the first preset distance; and

a selecting submodule 9022, configured to determine the second navigation device from the candidate navigation devices.

In this embodiment, a first navigation device searches for a second navigation device with a destination the same as or near a first destination, and establishes a communication connection to the first navigation device, which can automatically search for another navigation device related to the first navigation device for the first navigation device, helps the first navigation device acquire information related to the first navigation device, and improves user experience of a navigation device.

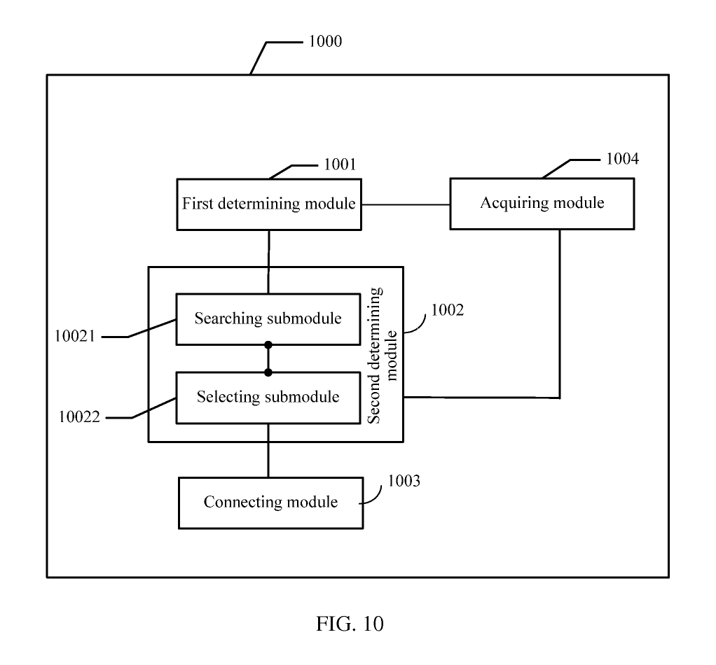

In the foregoing embodiment, a distance between a destination of a second navigation device that is determined by a first navigation device by means of automatic searching and a destination of the first navigation device is less than a first preset distance. In an actual application, the second navigation device may further meet the following condition: a navigation path of the second navigation device is the same as or near a navigation path of the first navigation device. The following describes a navigation device in an embodiment of the present invention. Referring to FIG. 10, a navigation device 1000 in another embodiment of the present invention includes:

a first determining module 1001, configured to determine a first destination currently navigated by a first navigation device;

a second determining module 1002, configured to determine a second navigation device, where a distance between a second destination currently navigated by the second navigation device and the first destination is less than a first preset distance; and

a connecting module 1003, configured to establish a communication connection between the first navigation device and the second navigation device.

In this embodiment of the present invention, the second determining module 1002 specifically includes:

a searching submodule 10021, configured to search for candidate navigation devices, where a distance between a destination currently navigated by each candidate navigation device and the first destination is less than the first preset distance; and

a selecting submodule 10022, configured to determine the second navigation device from the candidate navigation devices.

Further, the navigation device further includes:

an acquiring module 1004, configured to acquire a first departure place of the first navigation device, and acquire a first navigation path according to the first departure place and the first destination.

The searching submodule 10021 is specifically configured to determine the second navigation device from the candidate navigation devices, where a navigation path of the second navigation device and the first navigation path meet a preset condition.

It should be noted that the preset condition is preset by a holder of the navigation device, and the preset condition may be that a degree of coincidence between the navigation path and the first navigation path is greater than a preset value.

In this embodiment, a first navigation device searches for a second navigation device, where a navigation path of the second navigation device and a first navigation path of the first navigation device meet a preset condition. By using this solution, another navigation device more related to the first navigation device can be automatically searched for the first navigation device, which helps the first navigation device acquire information related to the first navigation device, and improves navigation device experience of a navigation device.

In another embodiment of the present invention, the acquiring module 1004 may also be configured to acquire a first trip purpose of a first user who uses the first navigation device; and the selecting submodule 10022 is specifically configured to determine the second navigation device from the candidate navigation devices, where a trip purpose of the second navigation device is the same as the first trip purpose.

In this way, the first navigation device searches for the second navigation device, where the destination of the second navigation device is the same as or near the destination of the first navigation device, and the trip purpose of the second navigation device is the same as the trip purpose of the first user who uses the first navigation device, and establishes a communication connection to the first navigation device, which can automatically search for another navigation device more related to the first navigation device for the first navigation device, helps the first navigation device acquire information related to the first navigation device, and improves navigation device experience of a navigation device.

In another embodiment of the present invention, the acquiring module 1004 may also be configured to acquire a device identifier input by the first user who uses the first navigation device; and the selecting submodule 10022 is specifically configured to determine the second navigation device from the candidate navigation devices, where a device identifier of the second navigation device is the same as the device identifier input by the first user.

In this embodiment, a first navigation device searches for a second navigation device by asking a first user to input a device identifier of the second navigation device that needs to be connected, so that the second navigation device connected to the navigation device better meets a requirement of the first navigation device, thereby improving use experience of a user.

In this way, the first navigation device may establish a communication connection between the first navigation device and another navigation device to help the first navigation device and the another navigation device exchange information required by each other, thereby improving use experience of a navigation device.

In this embodiment, the first navigation device may amend a first navigation path according to information about a latest real-time road condition, so as to avoid encountering a case such as road closure, road repair, or congestion, thereby improving the travel efficiency of a user.

For ease of understanding the foregoing embodiment, the following describes an interaction process of each module of the navigation device in a specific application scenario.

A first user needs to drive from place A to place B. After the first user starts a vehicle-mounted GPS device, an acquiring module detects a current position of the vehicle-mounted GPS device, and the first user manually inputs a specific position of place B. After the acquiring module acquires a first departure place and a first destination of the vehicle-mounted GPS device, a first calculating module calculates multiple paths between the first departure place and the first destination according to a map embedded in the first calculating module, and uses each of the paths as first candidate paths.

Then, the acquiring module acquires information about real-time road conditions of all the first candidate paths from a navigation server and calculates a predicted real-time road condition of each of the first candidate paths in a current period of time, where the information about the real-time road conditions includes a navigation path of another navigation device except the first navigation device, a current real-time road condition of each of the paths, an emergency occurring on each of the paths, and the like, and then the acquiring module chooses a path with a best real-time road condition as a first navigation path and presents the path to the first user.

Afterwards, the acquiring module acquires a current position every ten minutes, a searching submodule calculates all second candidate paths according to the current position and the first destination, the acquiring module acquires information about latest real-time road conditions of all the second candidate paths from the navigation server, and selects a path with the best real-time road condition from all the second candidate paths as a second navigation path according to the information about the latest real-time road conditions, so as to amend the first navigation path.

A second determining module searches for all candidate navigation devices according to the first destination of the vehicle-mounted GPS device, where the vehicle-mounted GPS device selects navigation devices with a distance between a destination and the first destination of the vehicle-mounted GPS device less than one hundred meters as the candidate navigation devices by default, and presents information about all the candidate navigation devices to the first user by using a display interface of the first navigation device.

The first user selects three candidate navigation devices among all the candidate navigation devices. A selecting submodule in the second determining module uses the three candidate navigation devices as second navigation devices, and a connecting module establishes communication connections between the vehicle-mounted GPS device and the second navigation devices. The first user inputs text data into the navigation device, and a communications module acquires the text data and sends it to each navigation device among the second navigation devices.

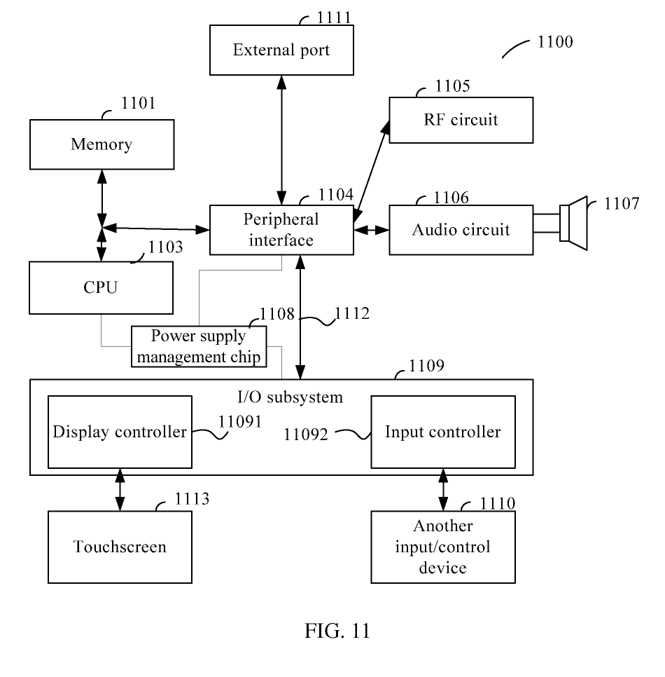

The foregoing describes the navigation device in this embodiment of the present invention from a perspective of a unit of a functional entity. The following describes a navigation device in an embodiment of the present invention from a perspective of hardware processing. Referring to FIG. 11, in this embodiment, the present invention is described in detail by using a vehicle-mounted GPS device as an example.

It should be understood that the vehicle-mounted GPS device 1100 shown in the figure is only an example of a navigation device, and the vehicle-mounted GPS device 1100 may have more or less parts than parts shown in the figure, may combine two or more parts, or may have a different parts configuration. Various parts shown in the figure may be implemented in hardware that includes one or more signal processing and/or application-specific integrated circuits, software, or a combination of hardware and software.

Specific description is performed by using the vehicle-mounted GPS device 1100 as an example. As shown in FIG. 11, the vehicle-mounted GPS device 1100 includes a memory 1101, a central processing unit (Central Processing Unit, CPU for short) 1103, a peripheral interface 1104, an RF circuit 1105, an audio circuit 1106, a speaker 1107, a power management chip 1108, an input/output (I/O) subsystem 1109, another input/control device 1110, and an external port 1104. These parts communicate by using one or more communications buses or signal cables 1112.

The following describes in detail the vehicle-mounted GPS device 1100 provided in this embodiment.

Memory 1101: The memory 1101 may be visited by the CPU 1103 and the peripheral interface 1104, and the memory 1101 may include a high-speed random access memory and may also include a non-volatile memory, for example, one or more disk storage components, flash memory components, or other volatile solid-state storage components.

Peripheral interface 1104: The peripheral interface may connect an input and output peripheral of the device to the CPU 1103 and the memory 1101.

I/O subsystem 1109: The I/O subsystem 1109 may connect the input and output peripheral, such as a touchscreen 1113 (equivalent to the display in the foregoing embodiment), on the device and the another input/control device 1110 to the peripheral interface 1104. The I/O subsystem 1109 may include a display controller 11091 and one or more input controllers 11092 configured to control the another input/control device 1110. The one or more input controllers 11092 receive an electrical signal from the another input/control device 1110 or send an electrical signal to the another input/control device 1110, where the another input/control device 1110 may include a physical button (such as a push button and a rocker button), a dial, a slider switch, a joystick, and a click wheel. It should be noted that the input controller 11092 may connect to any one of the following: a keyboard, an infrared port, a USB interface, and a pointing device such as a mouse.

Touchscreen 1113: The touchscreen 1113 is an input interface and an output interface between a mobile terminal and a navigation device, and it displays visual output to the navigation device, where the visual output may include graphics, a text, an icon, a video, and the like.

The display controller 11091 in the I/O subsystem 1109 receives an electrical signal from the touchscreen 1113 or sends an electrical signal to the touchscreen 1113. The touchscreen 1113 detects contact on the touchscreen, and the display controller 11091 converts the detected contact into interaction with a navigation device interface object that is displayed on the touchscreen 1113, that is, implementing man-machine interaction, where the navigation device interface object that is displayed on the touchscreen 1113 may be an icon for running a game, an icon for connecting to a corresponding network, or the like. It should be noted that the device may further include an optical mouse, where the optical mouse is a touch-sensitive interface that does not display the visual output or an extension of a touch-sensitive surface that is formed by the touchscreen.

The RF circuit 1105 is mainly configured to establish communication between a mobile phone and a wireless network (namely, a network side) to implement data receiving and sending between the mobile phone and the wireless network, for example, sending or receiving a short message service message, an email, and the like. Specifically, the RF circuit 1105 receives and sends an RF signal, where the RF signal is also referred to as an electromagnetic signal. The RF circuit 1105 converts the electrical signal into the electromagnetic signal or converts the electromagnetic signal into the electrical signal, and communicates with a communications network and another device by using the electromagnetic signal. The RF circuit 1105 may include a known circuit configured to execute these functions, including but is not limited to an antenna system, an RF transceiver, one or more amplifiers, a tuner, one or more oscillators, a digital signal processor, a CODEC chipset, a navigation device identifier module (Subscriber Identity Module, SIM), and the like.

The audio circuit 1106 is mainly configured to receive audio data from the peripheral interface 1104, convert the audio data into an electrical signal, and send the electrical signal to the speaker 1107.

The speaker 1107 is configured to restore a voice signal into a voice and play the voice to the navigation device, where the voice signal is received by the mobile phone from the wireless network by using the RF circuit 1105.

The power management chip 1108 is configured to perform power supply and power management for hardware connected to the CPU 1103, the I/O subsystem, and the peripheral interface.

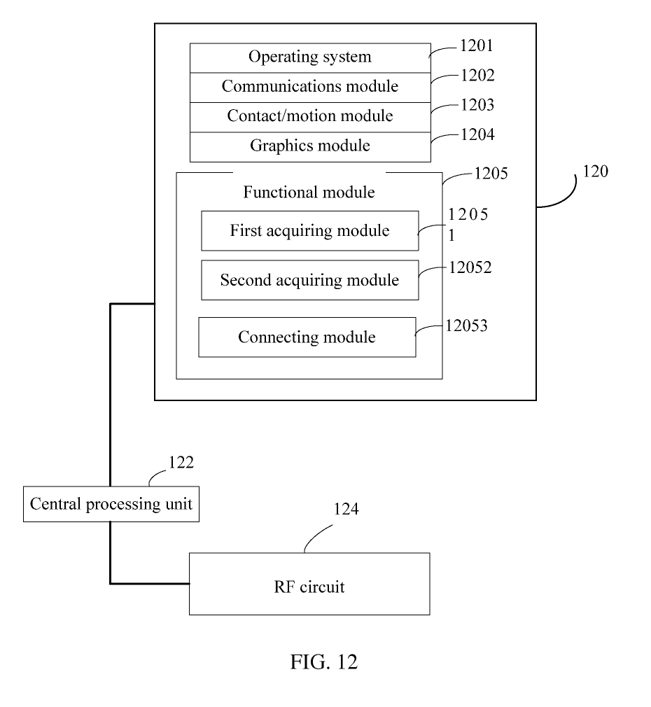

FIG. 12 is a structural diagram of an inner part of a vehicle-mounted GPS device. In this embodiment of the present invention, a software part stored in a memory 120 may include an operating system 1201, a communications module 1202, a contact/motion module 1203, a graphics module 1204, and a functional module 1205.

The operating system 1201 (for example, Darwin, RTXC, LINUX, UNIX, OS X, WINDOWS, or an embedded operating system such as VxWorks) includes various software parts and/or drivers for controlling and managing general system tasks (for example, memory management, storage device control, and power management), and facilitates communication between various hardware and software parts.

The communications module 1202 facilitates communication with another device through one or more external ports and also includes various software parts for handling data received by an RF circuit 124 and/or an external port.

The contact/motion module 1203 may detect a contact with a touchscreen (in conjunction with a display controller) and another touch-sensitive device (for example, a touchpad or a physical click wheel). The contact/motion module 1203 includes various software parts for performing various operations related to detection of contact, where the operations are exemplarily determining whether contact has occurred, determining whether there is movement of the contact and tracing the movement across the touchscreen, and determining whether the contact has been ended (that is, whether the contact has ceased). Determining movement of a contact point may include determining a speed (magnitude), a velocity (magnitude and direction), and/or an acceleration (a change in magnitude and/or direction) of the contact point. These operations may be applied to single contacts (for example, one-finger contacts) or applied to multiple simultaneous contacts (for example, “multitouch”/multi-finger contacts). In some embodiments, the contact/motion module 1203 and the display controller further detect contact on the touchpad.

The graphics module 1204 includes various known software parts for displaying graphics on the touchscreen, including a part for changing the intensity of the displayed graphics. For example, an instruction of the central processing unit 1103 is received, and a graphic navigation device interface with various types of software is displayed on the touchscreen.

The functional module 1205 may specifically include the following modules:

a first determining module 12051, configured to determine a first destination currently navigated by the first navigation device;

a second determining module 12052, configured to determine a second navigation device, where a distance between a second destination currently navigated by the second navigation and the first destination is less than a first preset distance; and

a connecting module 12053, configured to establish a communication connection between the first navigation device and the second navigation device.

The RF circuit 124 receives information sent by a network side or another device, where the information may specifically be the communication information in each of the foregoing embodiments. It may be understood that the received message may also be information of another type, which is not limited in this embodiment of the present invention. Persons skilled in the art may know that the received information may carry data of various data types. There may be data of only one data type, and there may also be data of two or more data types.

A central processing unit 122 recognizes a data type of data in the information received by the RF circuit 124, and stores, according to a correspondence list, the data onto a functional module corresponding to the data type of the data, where the correspondence list is a list of correspondences between data types and functional modules. The functional module 1206 may specifically include the first determining module 12051, the second determining module 12052, and the connecting module 12053. It may be understood that in this embodiment of the present invention, a manner of recognizing data of various formats by the central processing unit 122 may be performed in the manner in the foregoing embodiment, and details are not described herein again.

Specifically, the second determining module 12052 includes a searching submodule, configured to search for candidate navigation devices, where a distance between a destination currently navigated by each candidate navigation device and the first destination is less than the first preset distance; and a selecting submodule, configured to determine the second navigation device from the candidate navigation devices.

Specifically, the functional module 1205 further includes an acquiring module, configured to acquire a first departure place of the first navigation device, and acquire a first navigation path according to the first departure place and the first destination; the searching submodule is specifically configured to search for candidate navigation devices, where a distance between a destination currently navigated by each candidate navigation device and the first destination is less than the first preset distance, and a degree of coincidence between navigation paths of the candidate navigation devices and the first navigation path is greater than a preset value.

Specifically, the acquiring module is further configured to acquire a first trip purpose of a first user who uses the first navigation device; the searching submodule is specifically configured to search for candidate navigation devices, where a distance between a destination currently navigated by each candidate navigation device and the first destination is less than the first preset distance, and trip purposes of users who use the candidate navigation devices are the same as the first trip purpose.

Specifically, the acquiring module is further configured to acquire a device identifier input by the first user who uses the first navigation device; the searching submodule is specifically configured to search for candidate navigation devices, where a distance between a destination currently navigated by each candidate navigation device and the first destination is less than the first preset distance, and device identifiers of users who use the candidate navigation devices matches the device identifier input by the first user who uses the first navigation device.

Specifically, the acquiring module is further configured to acquire the first departure place of the first navigation device; the functional module 1206 further includes a first calculating module, configured to calculate all first candidate paths according to the first departure place and the first destination; the acquiring module is further configured to acquire information about real-time road conditions of all the first candidate paths from a navigation server, and acquire a first navigation path from all the first candidate paths according to the information about the real-time road conditions of all the first candidate paths, where the first navigation path refers to a candidate path with a best real-time road condition among all the first candidate paths.

Specifically, the acquiring module includes a first acquiring submodule, configured to acquire a navigation path of another navigation device except the first navigation device from the navigation server; a first calculating submodule, configured to calculate traffic flow of all the first candidate paths according to the navigation path of the another navigation device; and a first determining submodule, configured to, for each of the first candidate paths, use the traffic as information about a real-time road condition of the first candidate path.

Specifically, the acquiring module is further configured to acquire a current position at an interval of a preset time; the functional module further includes a second calculating module, configured to calculate all second candidate paths according to the current position and the first destination; the acquiring module is further configured to acquire information about real-time road conditions of all the second candidate paths from the navigation server, and acquire a second navigation path from all the second candidate paths according to the information about the real-time road conditions of all the second candidate paths, where the second navigation path refers to a candidate path with a best real-time road condition among all the second candidate paths.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual requirements to achieve the purposes of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. A navigation method, comprising:
determining, by a first navigation device, a first destination currently navigated by the first navigation device;
determining, by the first navigation device, a second navigation device, wherein a distance between a second destination currently navigated by the second navigation device and the first destination is less than a first preset distance; and
establishing, by the first navigation device, a communication connection to the second navigation device.

2. The navigation method according to claim 1, wherein the determining, by the first navigation device, the second navigation device comprises:
searching, by the first navigation device, for candidate navigation devices, wherein, for each candidate navigation device, a distance between a destination of the candidate navigation device and the first destination is less than the first preset distance, and the number of the candidate navigation devices is greater than 1; and
determining, by the first navigation device, the second navigation device from the candidate navigation devices.

3. The navigation method according to claim 2, further comprising:
acquiring, by the first navigation device, a first departure place of the first navigation device; and
acquiring a first navigation path according to the first departure place and the first destination;
wherein the determining, by the first navigation device, the second navigation device from the candidate navigation devices comprises: determining, by the first navigation device, that a navigation path of the second navigation device and the first navigation path meet a preset condition.

4. The navigation method according to claim 2, further comprising:
acquiring, by the first navigation device, a first trip purpose of a user who uses the first navigation device;
wherein the determining, by the first navigation device, the second navigation device from the candidate navigation devices comprises: determining, by the first navigation device, that a trip purpose of the second navigation device is the same as the first trip purpose.

5. The navigation method according to claim 2, wherein each navigation device has one device identifier uniquely identifies the navigation device; and the method further comprises:
acquiring, by the first navigation device, a device identifier input by a first user who uses the first navigation device;
wherein the determining, by the first navigation device, the second navigation device from the candidate navigation devices comprises: determining, by the first navigation device, that a device identifier of the second navigation device is the same as the device identifier input by the first user who uses the first navigation device.

6. A navigation device, comprising:
a first determining module, configured to determine a first destination currently navigated by a first navigation device;
a second determining module, configured to determine a second navigation device, wherein a distance between a second destination currently navigated by the second navigation device and the first destination is less than a first preset distance; and
a connecting module, configured to establish a communication connection to the second navigation device.

7. The navigation device according to claim 6, wherein the second determining module comprises:
a searching submodule that is configured to search for candidate navigation devices, wherein, for each candidate navigation device, a distance between a destination currently navigated by the candidate navigation device and the first destination is less than the first preset distance; and
a selecting submodule that is configured to determine the second navigation device from the candidate navigation devices.

8. The navigation device according to claim 7, further comprising:
an acquiring module, configured to acquire a first departure place of the first navigation device, and acquire a first navigation path according to the first departure place and the first destination;
wherein the selecting submodule is configured to determine the second navigation device from the candidate navigation devices based on a navigation path of the second navigation device and the first navigation path meeting a preset condition.

9. The navigation device according to claim 8, wherein:
the acquiring module is further configured to acquire a first trip purpose of a user who uses the first navigation device; and
the selecting submodule is configured to determine the second navigation device from the candidate navigation devices based on a trip purpose of the second navigation device being the same as the first trip purpose.

10. The navigation device according to claim 8, wherein:
each navigation device has one device identifier that uniquely identifies the navigation device;
the acquiring module is further configured to acquire a device identifier input by a first user who uses the first navigation device; and
the selecting submodule is configured to determine the second navigation device from the candidate navigation devices based on a device identifier of the second navigation device being the same as the device identifier input by the first user.
